(19) United States
(12) Patent Application Publication
(10) Pub. No.: US 2021/0282593 A1
(43) Pub. Date: Sep. 16, 2021

(54) TOASTER FOR BREAD AND TORTILLA FLAT BREAD

(71) Applicant: Jorge AGUILAR ROSIQUE, Villahermosa (MX)

(72) Inventor: Jorge AGUILAR ROSIQUE, Villahermosa (MX)

(21) Appl. No.: 16/324,938

(22) PCT Filed: Aug. 15, 2017
(86) PCT No.: PCT/MX2017/000095

§ 371 Date: Feb. 12, 2019

(30) Foreign Application Priority Data
Aug. 18, 2016 (MX) 2016/010785

(51) Int. Cl. A47J 37/08

(52) U.S. Cl. CPC A47J 37/08; A47J 37/0814

(57) ABSTRACT

The invention belongs to the field of kitchen electronic appliances, more specifically speaking food toasters. The invention shows a bread and tortillas toaster with a leaning angle that can vary from a rank between 45° and 89° with respect to a horizontal base (11), such leaning helps to distribute a portion of the weight of at least one tortilla (14) on an inferior grid (16). The bread slices or tortillas (14) rest on a main support base (20) with curved tabs that assemble a “V” shape (21) on the side of the inferior grid (16) and straight tabs (21′) on the side of the superior grid (17). The curved tabs (21) can guide, thanks to their curved shape, the circumference of the tortilla to avoid folding or breaking. The food item is pressed between the grids (16) (17) putting the inferior axis together (22) (22′) and then the superior axis (23) (23′) of both grids keeping a soft and thin food item from folding.

This invention belongs to the kitchen electronic appliances, specifically: food toasters

### BACKGROUND

This invention is for a bread and tortilla heater. Nowadays, there are many kitchen appliances for tortilla heating, such as the appliances shown in art documents before this: U.S. Pat. Nos. 6,546,844, 6,205,911, 5,584,231, 2,562,535, 7,094,991, 6,116,150 y US 201414773753. However, these appliances shown previously are complicated to manufacture and none of them is adapted, for heating a slice of bread such as the appliance of this invention.

On the other hand, we have the common bread toasters, which have mechanisms, usually actioned by springs placed together to move a base support to receive the bread and move it up and down, using either a lever or an automatic mechanism actioned by a clock.

This type of toaster, generally speaking, contains a couple of grids; one on each side inside of the compartment and between them, it warms the bread up. Such grids are vertical, one in front of the other one, have the function of centering, and holds the bread slice thanks to the mechanism, usually made of springs when the base that receives the bread is pulled down.

The issue with these kind of toasters that do not allow the tortilla to be warm or toasted is the base support. They have a base with flanges in a “V” form separated from each other that cannot hold the tortilla down properly. Some empty spaces between the flanges and the grids in which some thin meal or the tortilla itself can get stock. Other bases have a flat form that does not provide the tortilla with a support point, centered to avoid the tortilla from folding or getting stock when the support is moving between the grids. This invention overcomes any inconvenient mentioned previously of the known toaster's bases, providing to a flat and soft item, such as tortillas. The proper support, due to its form and the distribution of the grids make the base support adapted in the convenient form of the tortilla avoiding gaps between the flanges and the grids of the toaster. The tortilla gets introduced or is slided up, it will not get folded, rolled up or stock inside the toaster compartment due to the strength with which the tortilla is moved, or by getting stock in the gaps formed between the flanges and the grids in the known toasters.

Another issue of the conventional toasters that do not allow to heat tortillas up, is that such grids, by their distribution inside the toaster form gaps or lumps. The lumps, when sliding up the base on which the thin and soft item is, get it stock on the gaps or lumps formed by the grids and the outside of the toaster. The previous problem is solved thanks to this invention with a bridge with sliding properties that connects the grids, also with sliding properties, with an edge of the outside opening avoiding gaps or lumps, in which a bread or another soft and thin meal can get stock or folded.

Another problem with toasters is that the grooves that guide and support the axes of the grids that hold bread or tortilla do not approach each other enough. Both grids come together completely and totally to each other, which serve to firmly hold a tortilla and avoid bending, which does not happen in current roasters, therefore, to solve this problem, in this invention will be appreciated from the drawings that such slots are next to each other ensure that the grilles can join together completely and totally.

Another disadvantage of this kind of toasters is that the vertical arrangement of the racks and the support base does not help in the weight distribution of the tortilla to avoid folding to use its weight on its perimeter when inserted vertically. To solve this problem of weight distribution, this invention has a slope, which allows to distribute the weight of the tortilla with no damage. Although U.S. Pat. No. 6,205,911 mentions a toaster having an inclination. The inclination less than 45° to the horizontal base makes it difficult to introduce a soft, flexible pancake having to use both hands to do so because, with such a tilt range, no gravity is used so that the tortilla is introduced easily to fall under its own weight but folded; in the case of vertical toasters. Besides the ones mentioned before, another disadvantage of the patent is that the grooves where foods can be placed are limited to a measure 1, 27 cm wide, whereby such appliance does not solve the problem of changing the thickness of a food other as the case of a bread tortilla as does the invention described herein.

Also, some toasters have a tray at the level of the base of the toaster and distant from the slots where the food is pushed when it has been heated. If the heated food is a soft tortilla, such item hangs through the opening and in contact with the hot slot or it may fall, which causes the tortilla bend or break, which is an undesirable situation. This problem is solved by this invention by a continuous external receiving tray (not heat conducting) to the opening of the inner casing, thus is preventing tortillas from hanging by the opening of the inner casing that is commonly heated excessively. Besides being practical, the receiving tray of the invention also offers the advantage of preventing the user from burning, since the food item is there, it is hot, and so it can remain for a moment on the tray before the customer takes it.

As mentioned above, known in the previous art toasters, they have mechanisms crimping food through grids spring-loaded, either alone joining the tops of such grids or the lower or upper parts together. However, this can be a problem for a soft, thin as a pancake item because it can bent. Therefore, to solve this problem, the invention described here has the characteristic of good timing to lower the main support base with the tortilla or bread. The lower portions of the grids and shortly after their tops, and when putting the support base up, the tops of the gratings are separated first and then the lower parts, thus, by the time the tortilla comes down, this is pressed and immobilized to prevent curling or bending from the moment it begins to fall.

Additionally, this invention provides a devise that known toasters do not have, as it provides the function of making precise cuts partially when the grids press the item.

This invention covers the need to prevent one or more tortillas with different characteristics (thickness, flexibility, hardness, weight and moisture) when heated or toasted, move freely, bending or rolling up. At the same time, provides economic advantage because the same device is able to adapt both, heating and toasting food thinness and softness of a tortilla as the thickness and softness of a bread, with the additional advantage of toasting tortillas with partial cuts preset.

### BRIEF DESCRIPTION OF THE INVENTION

The item described is a toaster that useful for food items as thin and soft as a tortilla and as thick and hard as a bread, with the additional advantage of toasting tortillas with pre-established partial cuts. Such device includes one or more cases that have one or more openings on the superior part. Such cases have a leaning with a rank between 45° y 89° in regards to a horizontal base, such toaster has one or more slots placed in vertical walls of the cases through which superior and parallel axes go, forming an inferior and superior grid to hold an item. The grids are parallel to the walls of the cases forming a bridge with an edge of the slots, avoiding gaps or bumps

A central axe provides the grip for the tortilla. The axe can be between the inferior and superior grids, passing through the slots that are in the parallel walls of the cases. Such axes includes one or more tabs on it, in which a part of those tabs is next to the inferior grid, and another part of them is next to the superior grid. The tabs of the central axe have a space between them so that several slide rods can form a grid.

The toaster described here, includes a rest position in which the upper and lower grids are apart from one another without imprisoning a foodstuff, one or more tabs disposed along the central axis reach the grids, and the central axis is close to the openings. The toaster described here also includes a toasting position in which the upper and lower grids approach for pressing and centering a food item between, at least, one source of parallel heat with the parallel walls of the case, for which the central axis presents closeness to the bottom of the cases. The inferior and superior grids can have a plurality of rods, or by a smooth surface, which can present holes.

For this invention to be very particular, the toasting position can include the feature of closing in the superior and the inferior grids, using the inferior and then the superior axis. Also, the grids disposition in which the superior rods do not interfere with the inferior rods when coming closer. The toaster can also have one or more sharp ends on the superior grid.

The characteristic details of this bread and tortilla toaster are in the next description and the drawings attached.

### BRIEF DESCRIPTION OF THE IMAGES

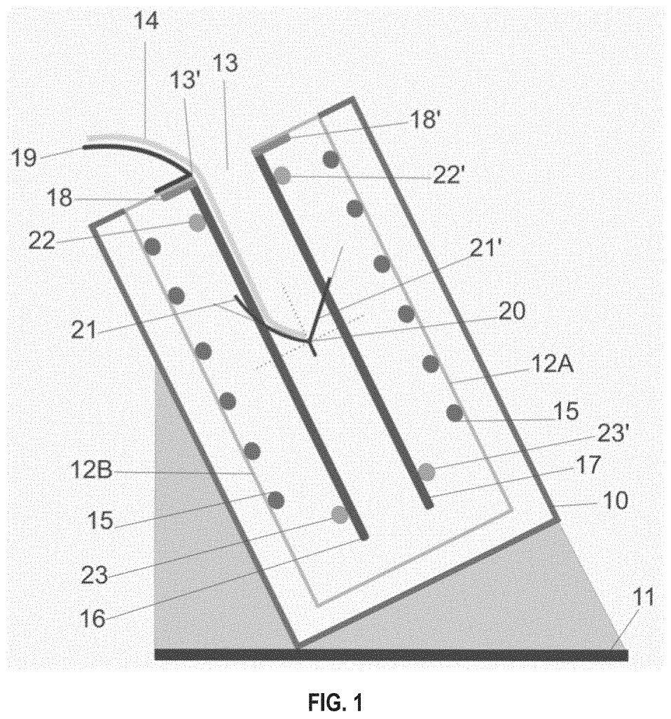

FIG. 1 shows a side view of the toaster device in rest position

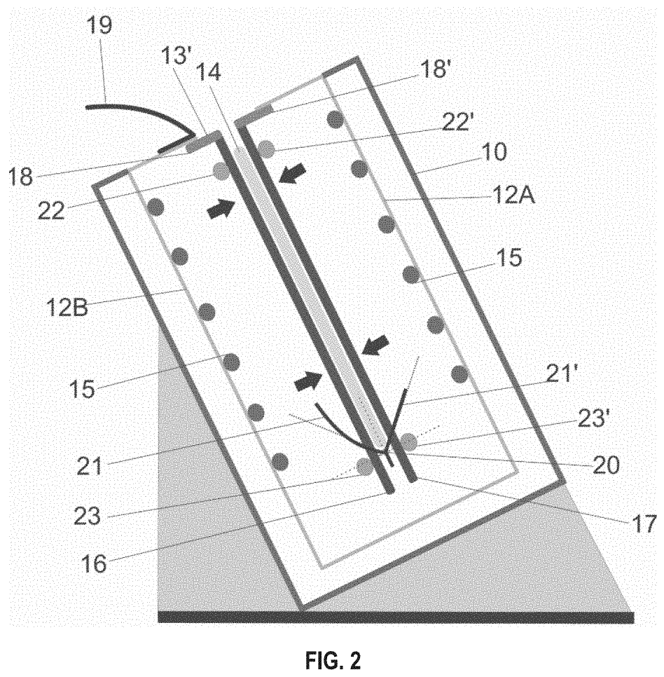

FIG. 2 shows a side view of the toaster device in position to toast a tortilla

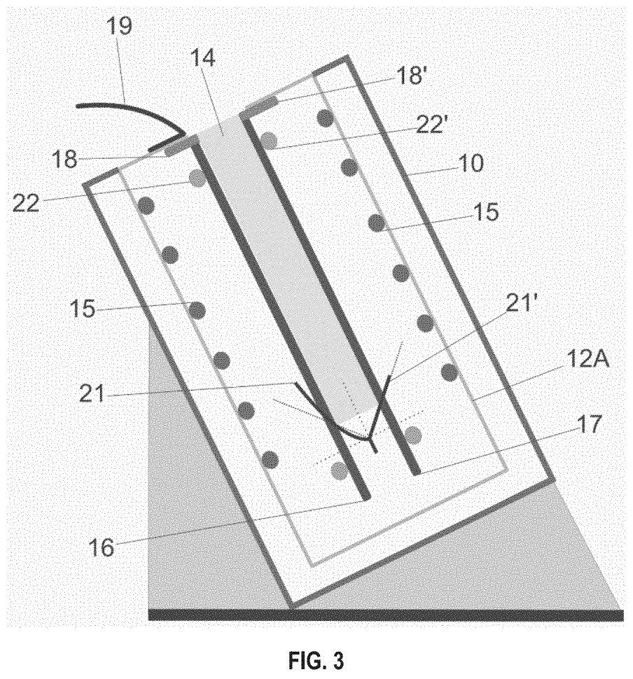

FIG. 3 shows a side view of the toaster device in position to toast a bread.

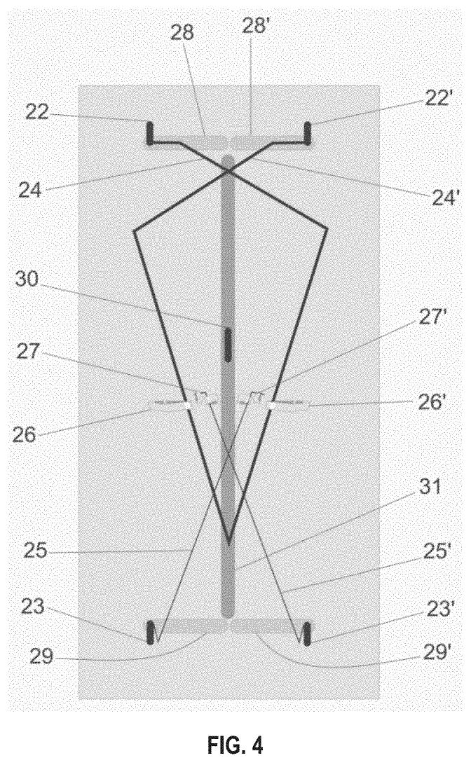

FIG. 4 shows a view of the wall 12C of the elastic metallic elements in rest position.

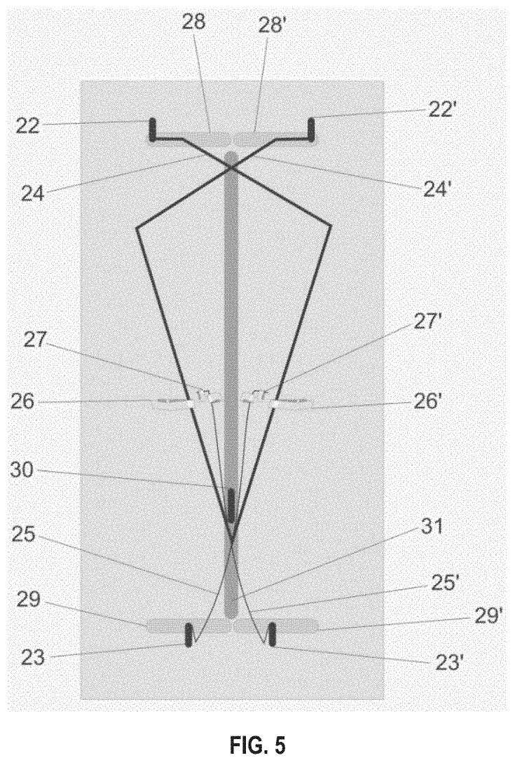

FIG. 5 shows a view of the wall 12C of the elastic metallic elements initiating toasting position.

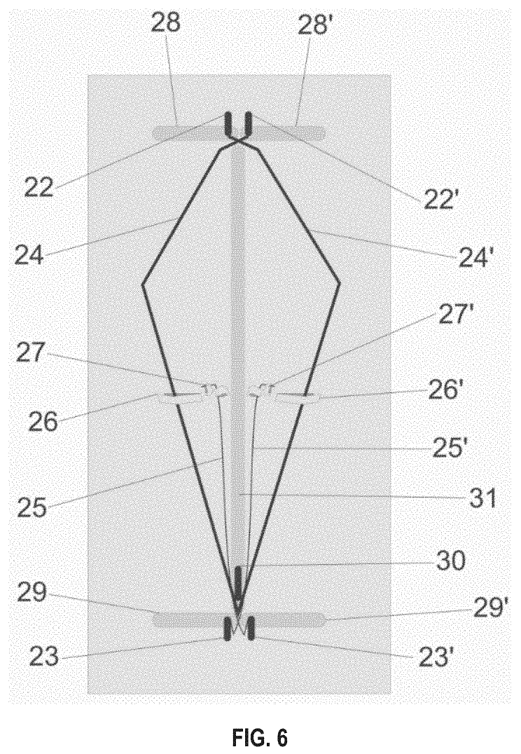

FIG. 6 shows a view of the wall of the elastic metallic elements in toasting position.

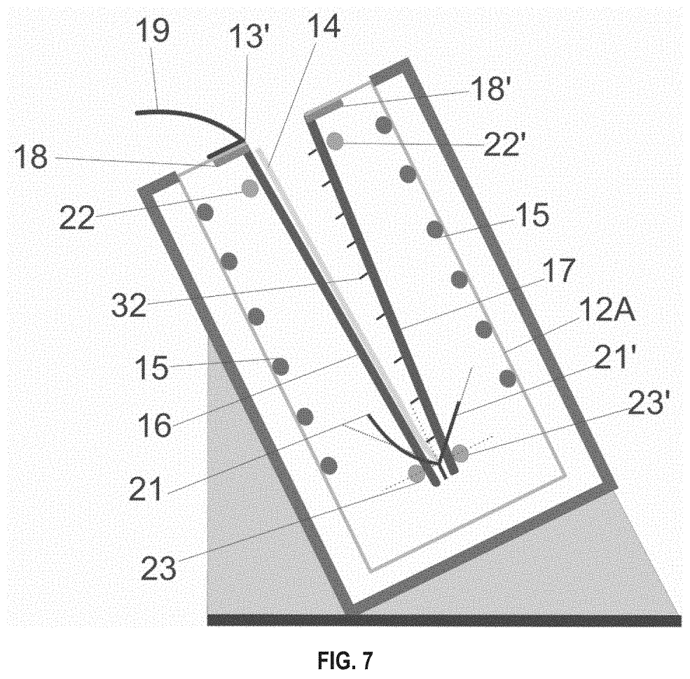

FIG. 7 shows a preferred mode of carrying out the invention in which the grids get close to each other first by the inferior part.

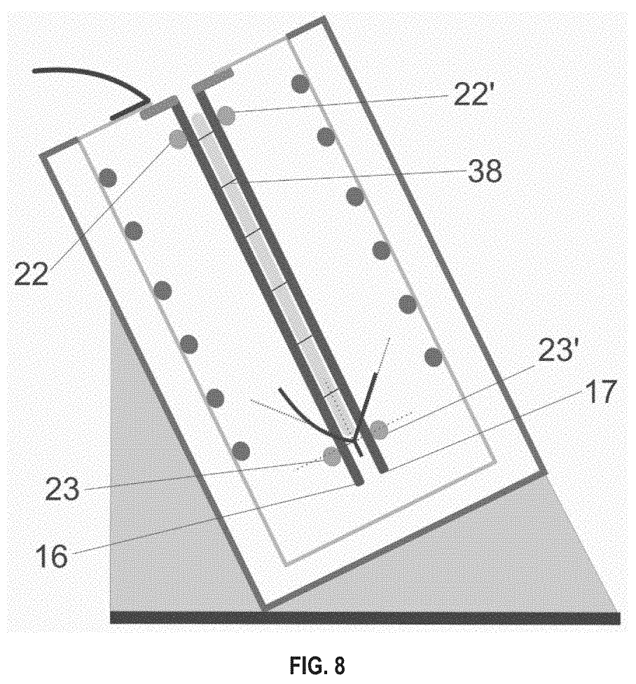

FIG. 8 shows the toasting position with the characteristic in which Sharp razors are making cuts on a tortilla.

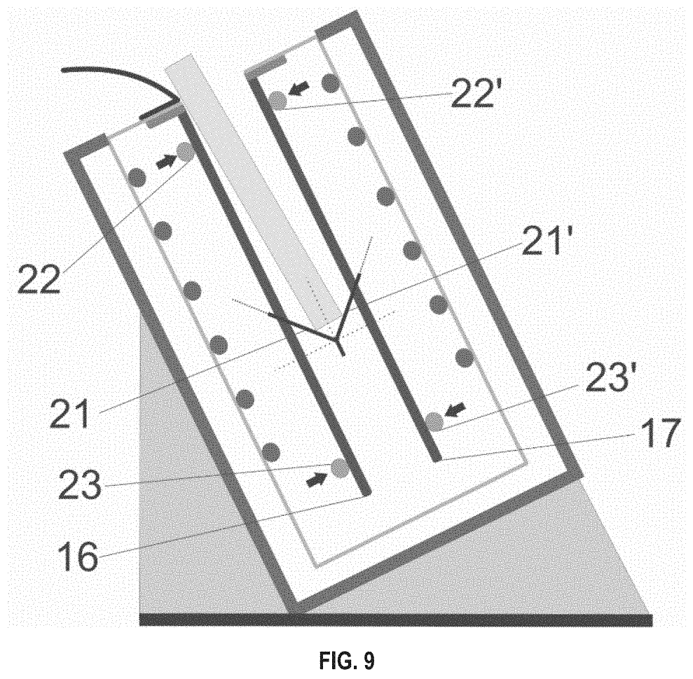

FIG. 9 shows an alternative way to carry out the invention in which both tabs in V are straight and the grids get close to each other by their inferior and superior axis at the same time.

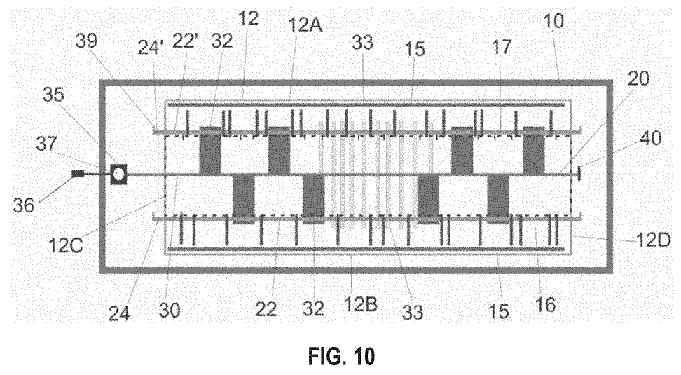

FIG. 10 is a superior view of the inside of the internal case that shows the grids in a rest position with the tabs disposed to carry out the invention

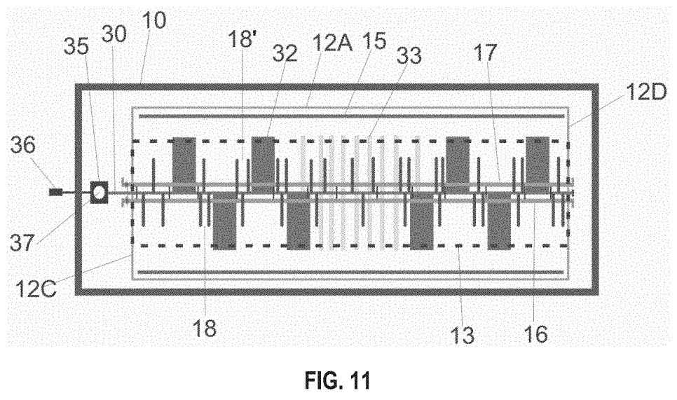

FIG. 11 is a superior view of the inside of the internal case that shows the grids in the toasting position.

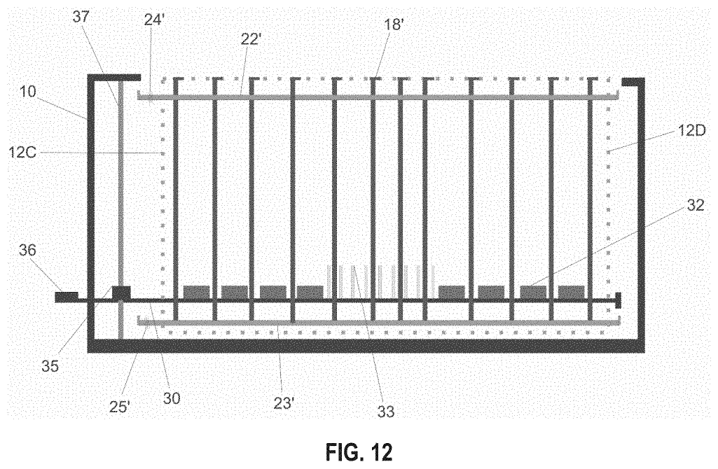

FIG. 12 is a view of the inside of the toaster

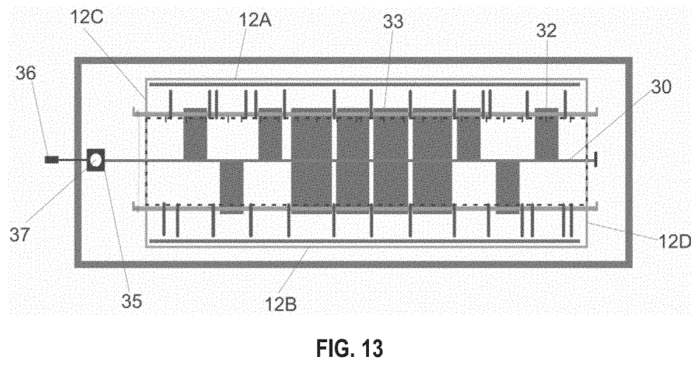

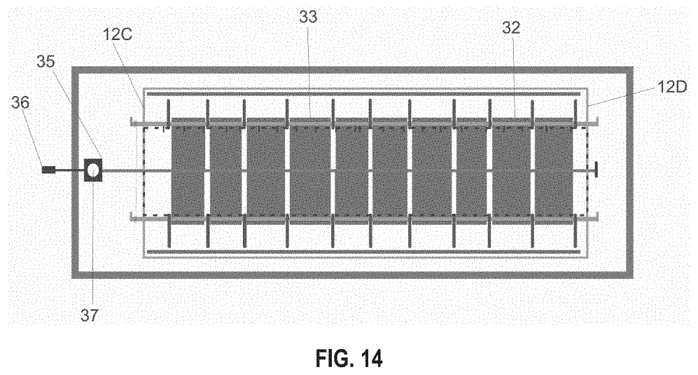

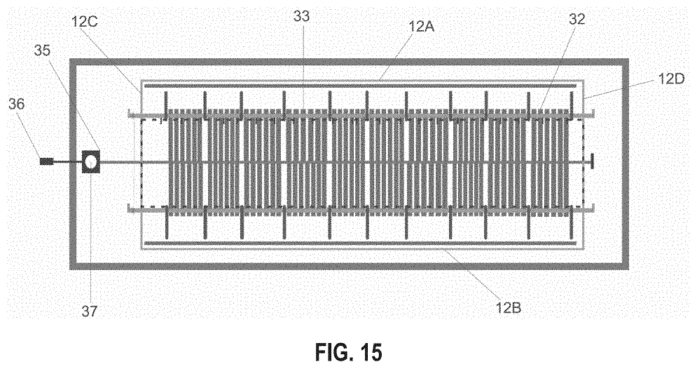

FIGS. 13, 14 and 15 are superior views of the inside of the internal case that show the grids in stand by position with the tabs in different position to carry out the invention

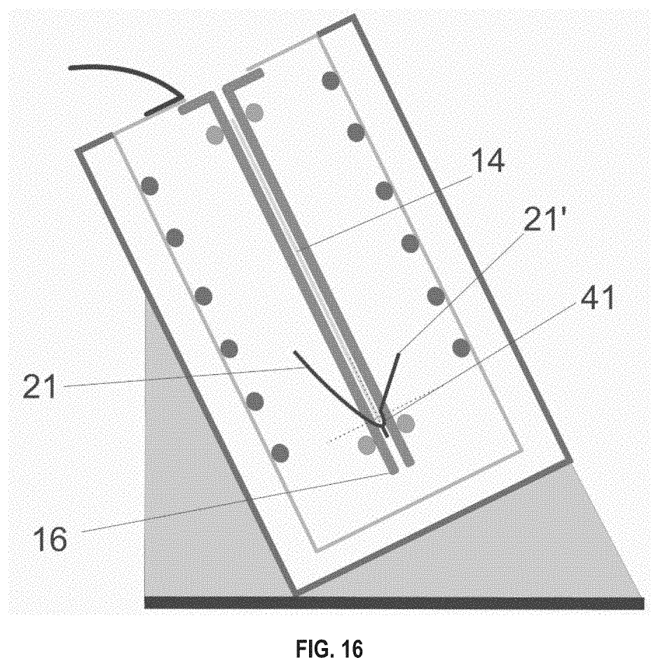

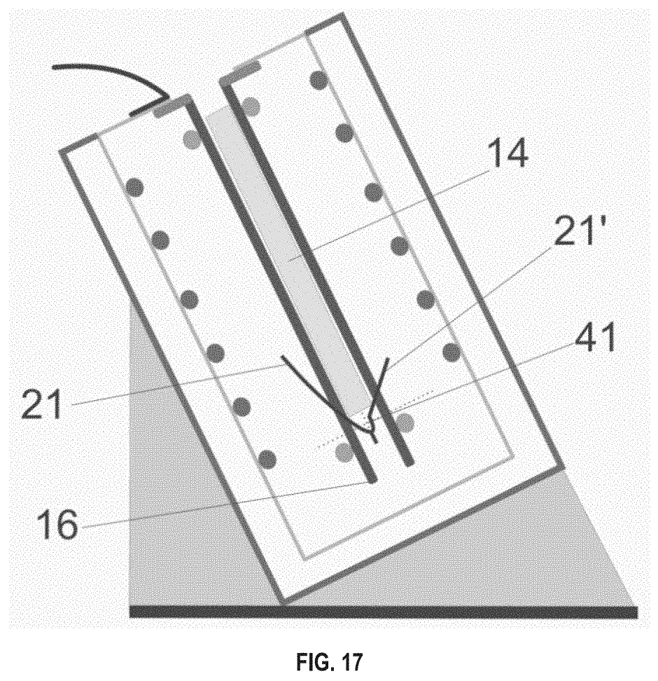

FIGS. 16 and 17 show the tabs in V in another way of carrying out the invention in which such tabs form a cavity.

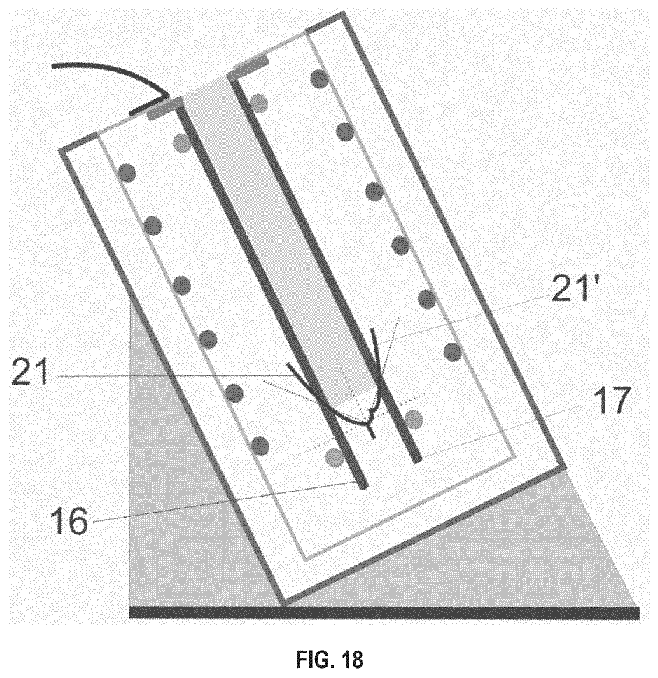

FIG. 18 shows another way of disposition of the tabs in the form of segmented curve.

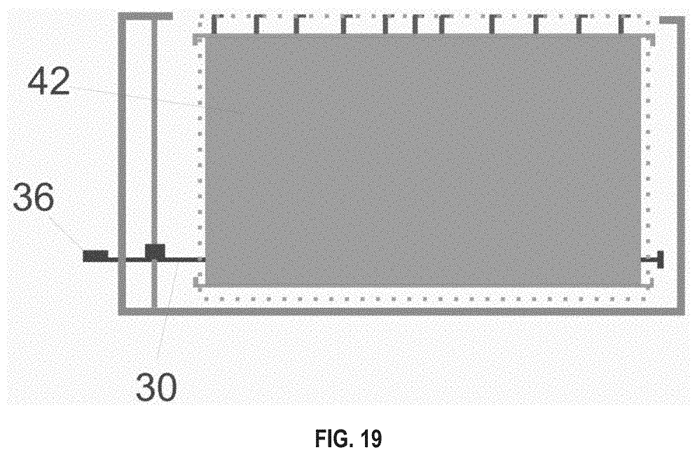

FIGS. 19, 20 and 21 show optional forms the inferior grid and the base that receives the tortilla can have.

### DETAILED DESCRIPTION OF THE INVENTION

Next, details of the invention in reference to the figures, which help better to understand the new aspects of it.

FIG. 1 shows a toaster device that has an external case (10), that has an inclination variating between 45° and 89° in regards to a horizontal base (11), such toaster has an inside case or compartment (12). The compartment follows the mentioned inclination, such internal case (12) has a superior opening (13) in which the bread or tortilla is placed (14). The inner case has at least one caloric source of energy (15) preferably parallel to the frontal (12A) and back (12B) wall of the inner case (12); such inner case (12) also has two mobile grids (16, 17), one inferior grid (16) and one superior grid (17) that are also parallel to the frontal (12A) and back (12B) wall. Its functions are: holding and center a bread or a tortilla (14). The mobile grids (16, 17), have a superior axis (22, 22′) and an inferior one (23, 23′) (described below), which hold the body of the grids, that could have a plurality of rods (18, 18′) that form an L bridge.

The main purpose of the inclination between 45° and 89° is to distribute part of the weight of the tortilla (14) on the inferior grid (16), so that it will not bend when holding its weight on the perimeter like it would happen in a toaster in which the grids are at 90°. Such inclination over 45° is also useful to avoid for a soft tortilla from folding due to it getting too close to the grids or the opening of a toaster, because of the inclination less than 45°, which does not allow to use the weight of the tortilla when placed.

In FIG. 1, can also be appreciated that the L bridge (18, 18′) formed of the rods, or wires that form the grids that move (16, 17), forms a bridge with an edge (13′) of a superior opening (13). For the inferior grid, it is close to a receiving support or tray (19) which is curved, although not limited to be completely or partially straight and not heat conducting placed on the edge (13′), of the superior opening (13), on the superior side of the interior case (12). This way, the edge (13′) of the superior opening (13), the receiving support or tray (19) and the “L” bridge form a smooth surface without gaps or bumps to allow the tortilla (14) to slide on the grids (16) and not getting stock.

The receiving support or tray (19) has the function of receiving the tortilla and keep it from hanging when the toasting process is over and the tortilla comes out of the toaster, keeping it from breaking or folding wrongly. This receiving support (19) also offers the advantage of avoiding burns, because when the food item comes out toasted, it is hot, so it can stay there on the tray to cool down. Such support is preferably in curve form although it is not limited, and could be straight or partially curved.

Also, between the movable grids (16) (17) there is a support, a primary base (20) on which the bread or tortilla is received (14). Such base, together with the receiving support (19), the “L” bridge (18), the edge (13′) of the superior opening (13) and the inferior grill (16) form a surface with no bumps or gaps in which a tortilla could get stock.

From the previous information, it must be understood that the toaster here shown can include one or more exterior casings (10) that contain one or more elements mentioned above or below described.

The toaster described here includes two positions for the movable grids (16), (17) and for the base support (20), a rest position and a toasting position. FIG. 1 shows the resting position which consists of the movable grids (16), (17) get separated from each other without having a grip of the food item between them and the support base (20) close to the superior opening (13). In addition, there are some tabs lined up (21), (21′), which go through the movable grids (16), (17). On the other hand, FIG. 2 shows the toaster on its toasting position, which happens when the movable grids (16), (17) get close to each other to hold the bread or tortilla (14), while the main support base (20), formed by the tabs (21) (21′) is closed to the inferior edges of the movable grids (16), (17). Besides all this, in a preferred way of carrying out the invention, the tab distribution has a “V” form. (21) (21′). A first portion of those tabs (21) is next to the inferior grid (16) and can be curved, while a second portion of those tabs (21′) is next to the superior grid (17), and can have a straight shape. The curved tabs (21) can guide due to the curve, the thin and soft tortilla providing support and the needed direction to avoid folding it or breaking it and the straight tabs (21′) can stop and hold the tortilla to center it between the curved and straight tabs. However, the shape of the tabs (21) on the side of the inferior grid is not limited, so they can also be straight as observed in FIG. 9, just as is not limited to the tabs on the superior's grid side (17) to be partially straight or curved, totally curved or with segmented curves. The tabs pointed previously (21′) which shape is not limited, the ones on the side next to the superior grid (17) have the function of forming a gap with the tabs (21) that are next to the inferior grid (16) to hold at least one tortilla. Such gap can have any desired shape, like “V” or “U”, “L” leaning to the left or any other according to the angle of the tabs (21) (21′).

Preferably, the angle of leaning of the tabs (21) in regards to an imaginary axis parallel to the grids (16) (17) marked with dotted lines in FIGS. 1 and 3 achieves a better performance. To heat a food item, thicker like a bread (14) in the toasting position if the leaning of the tabs is in “V” shape (21) (21′) the ideal leaning is between 40 and 70 degrees, each one parting from the imaginary axis parallel to the grids (16), (17) marking it with dotted lines. It is also preferable that the leaning angle of the tabs (21) on the side of the inferior grid (16) is minor than the angle of the tabs (21′) on the side of the superior grid (17) in regards to the imaginary axis parallel to the grids (16) (17) marked with the dotted line. As observed in FIG. 3, when warming up a thicker food item like a bread slice (14), it is well centered between the grids (16) (17) and between the heat sources (15). Provides a consistent toast due to its perimeter's support equally on the tabs (21) of the inferior's grid side (16) than on the tabs (21′) on the superior grid.

If the leaning angle of the tabs (21) on the inferior's side grid (16) was not minor than the angle of the tabs (21′) on the superior's grid side (17), a food item as thick as a bread slice would not be equally held on both tabs (21) (21′). Therefore, the bread slice would not be between the grids correctly during the toasting process.

Nevertheless, the tabs (21) of the inferior grid (16) also may have equal or different leaning angles related to the tabs (21′) on the side of the superior grid (17) parting from the imaginary parallel line to the grids.

In a preferred way to carry out the invention shown in FIG. 7, the resting and the toasting position mentioned previously function separating or closing in each other, first the inferior axis (23) (23′) and then the superior axis (22) (22′) of both grids. This is caused due to the effect of the elements of FIG. 4, which has some elastic elements, that can be several metallic elastic (24) (24′) tied to the superior axis of the grids (16) (17) and to the inferior grids (23) (23′). As an example, in FIGS. 4 to 6, the superior metallic elastics (24) (24′) have a point in “V” shape, besides, the superior metallic parts (24) (24′) and the inferior ones (25) (25′), are held by support tabs of superior metallic elastics (26) (26′) and inferior ones (27) (27′) respectively. The previous features have the intention of holding and guide the movement of the superior metallic elastics (24) (24′) and inferior ones which are attached to the superior axis (22) (22′) and inferiors (23) (23′) respectively to the movable grids (16) (17). The superior axis (22) (22′) and inferior ones (23) (23′) of the movable grids (16) (17), through superior guidance slots (28) (28′) and inferior ones (29) (29′), which are distributed in both sides (12C) and (12D), and such walls (12C) and (12D) are parallel to one another and are part of the inside case (12). The horizontal gap between slots, superior (28) (28′) and inferior (29) (29′) must be reasonable to allow bot grids (16) (17) to get close enough to one another in the toasting position to hold a food item, like a very thin tortilla.

The superior axis (22) (22′) and inferior ones (23) (23′) can have an optional edge stop (39) (in FIG. 10) to avoid the tortillas to fall off the superior and inferior guidance slots (28) (28′), (29) (29). The movement of the superior metallic elastics (24) (24′) and inferior ones (25) (25′9 when a central movable axe (30) in the shape of a rod which is part of the base support (20) slides down the central slots (31), which are similar and concentrically to each other in both side walls 12C and 12D of the inner case (12). The central movable axe (30) can also have an edge stop (40) on one end to keep it from coming out of the sided wall 12D of the inner case. It can also have a mechanism, which allows it to slice consistently through the central slot (31). As an example, on the FIGS. 10 to 15 such mechanism has a movable carrier (35) that is attached to a lever (36) auctioned by the user who makes it slide down through a pedestal (37). Also, the bread and tortilla toaster appliance can have time and temperature regulators, as well as switches that can stop the heating process and expel the food item.

On FIGS. 4 and 5 the superior metallic elastics (24) (24′) and inferior ones (25) (25′) are crossed in the central slot (31). When the movable central axe (30) is slided to the bottom of the inside case (12) in a toasting position to warm the bread or tortilla up, the inferior elastics (25) (25′) are moved causing the inferior axis (23) (23′) of both grids (16) (17) get together when sliding on the inferior slots (28) (28′) as the FIGS. 5 and 7 show.

After this, once the central movable axe (30) gets to the V shaped point and starts pulling the superior metallic elastics (24) (24′), the superior axis (22) (22′) of the movable grids get close until the central one (30) gets close to the bottom of the internal case (12) or close to the inferior axis (23) (23′). It happens in a toasting position in such a way that both grids (16), (17) get as close as possible to each other to hold and center the bread slice or tortilla (14) like in FIGS. 2 and 3 for the strength on the metallic elastics that stretch as needed.

The action of getting close to each other, first, the inferior axis (23) (23′) and then the superior ones (22) (22′) of both grids explained above is very useful. When the main support base (20) that holds the tortilla (14) slides to the bottom of the inside case (12), the tortilla is pushed to the superior grid. The tortilla (14) starts taking a flat shape after getting in contact with the main support base (20). Gets in contact with the tabs (21) of the inside grid (16) all the way to the bottom of the inside case where the tortilla goes completely flat for being hold tight with two grids (16) (17).

Despite the preferred way to carry out this invention, FIG. 7 shows the tortilla (14) can also be held in the grids (16) (17) if the toasting position takes place making the superior axis getting closer (22) (22′) as FIG. 9 shows.

In another way of carrying out with the invention (not shown), the resting and toasting positions can be possible using a metallic elastic wire, in which one end is attached to a fixed hook on the inside casing wall. Such holder is on the superior's side grid and on the central axe slot guide's side; such wire on its other end is held to the inferior axe of the inferior grid. Also, a metallic elastic wire is backwards on the opposite side that holds the inferior axis of the superior grid. The wires make the shape of an X that matches with the guiding slot of the central axis, such wires are pushed and pulled by the flat bar incorporated to the movable central axis. The wires pull the inferior axis of both grids until they are completely together and go back to the resting position due to a tensor when the flat bar is removed.

FIGS. 7 and 8 show some sharped points (38), which can be either fixed or removable from the superior grid (17) and which function is to make regular cuts to the tortilla (14). When the tortilla is pressed between two grids in the toasting position, it is covering the need of making partial and precise cuts in a practical and easy way, established according to the design and accommodation of the points.

FIG. 10 is a view of how the elements are distributed inside a toaster, showing the tabs (21) (21′) (seen from above) disposed in a first way to carry out the invention, in which the support base (20) is located between the superior (17) and inferior grids (16). The support base is constituted of wide tabs (32) making a V with a wide space between them and their function is to carry the bread slice. Such base support (20) is also constituted for thin tabs (33) also forming a “V” with less space between them than the wide tabs, the space is preferably in the rank from 1 mm to 2 cm which main function is to carry the tortilla avoiding wide gaps to keep it from folding or jamming.

Also, the heat sources (15) are parallel to the grids (16) (17) and the superior metallic elastics (24) (24′) hold the superior axis (22) (22′) of both grids (16) (17).

The main function of the thin tabs that are in the center (33) is to guide, stop and hold the tortilla. Such thin tabs (33) are the same as the partially curved tabs (21) on the inferior grid's side (16) and straight ones (21′) on the superior grid (17) as mentioned before on figure's 1 description, guiding with its curved shape the soft and thin tortilla providing support and direction to avoid folding or breaking. However, how it was mentioned before, the shape of the thin tabs (33) is not limited, so they can also be straight as FIG. 9 shows, and also, its leaning angle is not limited to the ones mentioned before.

The wide tabs (32) and thin tabs (33) have a length that allows them to reach the grids (16) (17) and preferably go through them, when they are in the resting position; with the previous information there is the advantage of no gaps or bumps through which an item as thin and soft as a tortilla could jam.

FIG. 11 shows a toasting position in which the gaps between the wide (32) and thin (33) tabs are ready to receive the rods (18) (18′). Rods form the “L” bridge of the superior grids (17) and inferior (16) so such gaps allow the rods (18) (18′) of the grids (16) (17) to slide between the tabs (32) (33) to get as close as possible and be able to toast. According to the previous information, the mobile central axis (30) must be thin enough to allow the mobile grids to get as close as possible between them to hold very thin tortillas.

In other words, the closeness of bot grids (16) (17) during the toasting process is given by the thickness of the central mobile axis (30) and by the horizontal separation between slots, superior (28) (28′) and inferior (29) (29′).

For more clarity, FIG. 12 shows with details the distribution of the superior (22′) and inferior (23′) axis of the superior grid (17), which are parallel between them and hold the rods perpendicularly (18′) forming the “L” bridge.

It is necessary to mention that such distribution of the axis (22) (23) with the rods (18) is the same for the inferior grid elements (16). This same figure shows how the rods of the “L” bridge (18′) fit with the tabs (32) (33) distributed along the mobile axis (30) and joined they make the central base support (20). The base support is assembled to the mobile carrier (35) that goes through the pedestal (35) when the lever goes up or down (36) which causes the movement of the axis (22′) (23′) of the grid (17) due to the metallic elastics (24′) (25′) attached to the axis (22′) (23′).

FIG. 11 shows both superior (17) and inferior grids (16) in the toasting position. An optional characteristic that allows both grids (16) (17) to get completely together to hold a food item as thin as a tortilla is that the rods (18) that form the “L” bridge of the inferior grid (16) do not fit with the rods (18′) of the superior grill (17) when coming closer to hold the tortilla more efficiently. FIGS. 13, 14 and 15 show other ways to carry out the invention, in which the wide (32) and the thin (33) tabs in “V” shape allow the rods (18) (18′) of the mobile grids (16) (17) to slide down between the tabs (32) (33) that create the base support (20) and the tabs including or not the mobile axis.

FIGS. 16 and 17 show another distribution of the tabs in “V” shape to receive the tortilla (14), in which such tabs (21) (21′) form a gap (41) with hooked shape with the necessary size to receive at least one tortilla. The gap (41) is formed thanks to the tabs (21) (21′) distributed along the central axis (30) and FIG. 16 shows that the gap (41) allows the thin tortilla in (14) but not a thick bread slice (14) like in FIG. 17. Also, for this mode, such tabs (21) (21′) can be curved with no limitations, straight on the inferior grid's side (16) or with segmented curves like the FIG. 18 shows.

On the other hand, the bread and tortilla toaster can have different devices or mechanism points that regulate the height of the base support (20) by the mobile central axis (30), to adjust it to the height of the food item that will be toasting. As an example of this mechanisms, there can be in an optional way a plurality of horizontal slots (not shown) disposed in the vertical slot (31) through which the central axis passes by (30).

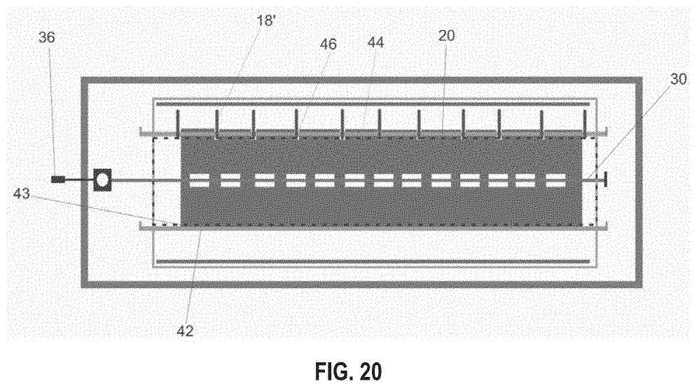

In an additional way to carry out the invention, the body of the inferior grid (16), in the cases that FIGS. 19 and 20 show, now it is a tray or inferior Surface (42) completely smooth, flat and uniform in which the superior end of the main support base, slides down (20). This other main support base does not have any tabs, but just one tab that includes the inferior tray (42) and when a lever (36) auctions it assembled to the central mobile axis (30), such superior end (43) of the main base support (20) sweeps like a shovel the surface of the inferior tray (42). This way of carrying out the main base support (20) is not limited to have only one tab, but it can also be formed, like mentioned before, with tabs either wide or thin tabs with different shapes and angles, besides the spaces between such tabs can be reduced or wide, but tight enough for the tortilla not to jam. Optionally, the main base support (20) with just one tab can have openings or holes (44) on its lower part so that crumbs do not accumulate. Also, in the mode in which the main base support has one tab, that tab alternatively, can have slots (46) through which the rods (18′) of the grids pass.

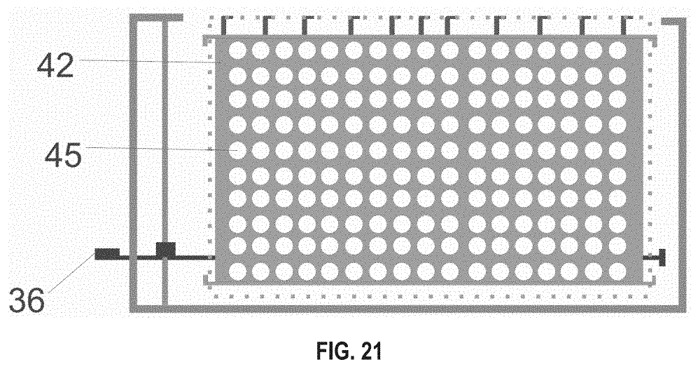

Additionally, such inferior tray (42) like FIG. 21 shows can have openings (45) of different sizes and shapes so that the tortilla or bread do not get moist. Such inferior tray with opening is also useful for the heat to get directly to the tortilla or bread slice.

On the other hand, the inferior tray (42) and the superior grid (17) can be still, so that the central mobile axis (30) descends and ascends along the main base support (20) and its tabs (21) (21′), according to the mode in which the invention is carried out.

As an option, the configuration of the inferior grid (16) mentioned before, just like FIGS. 19, 20 and 21 show can also be there for the superior grid (17), which means that such superior grid can be a tray completely smooth, flat and uniform and have holes or openings (45) of different sizes and shapes as FIG. 21 shows.

The current invention is for not only warming up bread or tortilla but it can warm one or more tortillas at the same time, or any type of food as long as the mechanisms mentioned before can receive it and expel it.

Finally, the language used to describe this invention has the main objective of legibility and instruction but not to go around the inventive matter. Therefore, the objective is not to limit the reach of the invention due to the written description, but for any of the following claims.

What is claimed is:

1. A toaster to warm food up that includes:
One or more cases that have either one or more openings on the superior part, such cases have an inclination in a rank between 45° and 89° in regards to a horizontal base;
one or more slots that are on walls, parallel to the cases through which superior and inferior parallel axis between them forming an inferior and superior grid, which are parallel to the case walls and also, forming a bridge with openings of the cases that do not allow gaps or bumps;
a central axis placed and located between the grids (inferior and superior) that goes through the slots found on the parallel walls of the cases, this central axis includes one or more tabs distributed along it, where a portion of the tabs is next to the inferior grid, while another portion of the tabs is next to the superior grid;
Wherein when a resting position is in process, in which the superior and inferior grids are set apart from each other without holding a food item, the tabs distributed along the central axis reach the grids and the axis is close to one or more openings; and
Wherein when a toasting position is in process, in which the superior and inferior grids get together to hold and center a food item between at least, one caloric source that is parallel to the inside casing walls, for which the central axis shows closeness with the bottom of the cases.

2. The toaster to warm food items according to claim 1, in which the body of the inferior and superior grids contains a plurality of rods.

3. The toaster to warm food items, according to claim 1, in which one or more tabs distributed along the central axis get apart from one another so that they allow the plurality of rods to slide down between them.

4. The toaster to warm food items according to claim 1, in which one or more tabs distributed along the central axis have a separation between each other, this separation varies from 1 millimeter and 2 centimeters.

5. The toaster to warm food items according to claim 1, in which the toasting process also includes:
When putting the grids close to each other (superior and inferior) first by its inferior axis and then by the superior ones; a disposition of the grids in which the plurality of the inferior grid's rods do not fit with the rod's plurality of the superior grid during the movement of the grid getting close to each other.

6. The toaster to warm food items, according to the claim 1, that includes metallic elastics tied to the superior and inferior axis that are tense or lose by the auctioning of the central axis sliding up or down through the slots located on the parallel cases to carry out the toasting and the resting process.

7. The toaster to warm food items according to any of the claim 1 or 6, that includes an attached lever to a pedestal or an automatic mechanism auctioned with the temporizer to be able to slide the central axis through the slots that are on the parallel walls of the cases.

8. The toaster to warm food items according to claim 1, in which the case has at least one caloric source parallel to the casing walls.

9. The toaster to warm food items according to claim 8, in which the caloric source includes time and temperature regulators, as well as mechanisms, which cancel the toasting process.

10. The toaster, to warm food items according to claim 1, in which the leaning angle of the portion of the tabs that are next to the inferior grid is minor than the angle of the other portion of the tabs that are next to superior grid, with respect to an imaginary axis parallel to the superior and inferior grids.

11. The toaster to warm food items according to claim 1, in which the tabs that form the central axis have one or more curves.

12. The toaster to warm food items according to claim 1, in which the tabs that form the central axis make a gap.

13. The toaster to warm food items according to claim 12, in which the gap has a “V” shape.

14. The toaster to warm food items according to claim 12, in which the gap has a hook shape.

15. The toaster to warm food items according to claim 12, in which the gap has “U” shape.

16. The toaster to warm food items according to claim 12, in which the gap has “L” shape.

17. The toaster to warm food items according to claim 12, which also includes:
One or more receiving supports that are above the cases.

18. The toaster to warm food items according to claim 1, in which the closeness of the central axis to the openings or to the bottom of the case is adjustable.

19. The toaster to warm food items according to claim 1, in which the superior grid holds one or more Sharp points.

20. The toaster to warm food items according to claim 1, in which the body of the inferior and superior grids is formed of a smooth surface.

21. The toaster to warm food items according to claim 20, in which the smooth surface has holes.

22. The toaster to warm food items according to claim 1, in which the toasting process also includes the procedure of getting the superior and inferior grids close to each other by its inferior axis at the same time than by its superior axis.

23. The toaster to warm food items according to claim 1, in which a leaning angle of one portion of the tabs distributed next to the inferior grid is the same as the angle of the other portion of the tabs distributed next to the superior grid with respect to an imaginary axis parallel to the superior and inferior grids.

24. The toaster to warm food items according to claim 1, in which the tabs that form the central axis are straight.

25. The toaster to warm food items according to claim 1, in which the tabs that form the central axis have openings.
